(19) United States
(12) Patent Application Publication
(10) Pub. No.: US 2010/0318987 A1
(43) Pub. Date: Dec. 16, 2010

(54) BOOTSTRAPPING STREAMED AND VIRTUALIZED APPLICATIONS

(75) Inventors: Paul Clay Barr, Redmond, WA (US); Joe Keng Yap, Sammarrish, WA (US); Bradley M. Corob, Kirkland, WA (US); Anzhelika Nishanova, Redmond, WA (US); Gurashish Singh Brar, Redmond, WA (US); Anthony Douglas Krueger, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/484,366

(22) Filed: Jun. 15, 2009

(51) Int. Cl. G06F 9/445; G06F 15/16

(52) U.S. Cl. 717/176; 709/231

(57) ABSTRACT

Technologies are described herein for bootstrapping streamed and virtualized applications from a network. Bootstrapping features may be deployed entirely over hypertext transfer protocol (HTTP) or other file download, or file transfer, mechanisms. A bootstrap loader, or bootstrapper, may provide the user interface (UI) elements during launch of an application from a network. Prerequisites, system requirements, languages, and localization for the application may be supported. Consistent UI elements may be presented starting with the bootstrapper through to the streaming and initial execution of the application. Consistent UI elements and rapid streamed downloading can provide a user with a boot-like user experience even for an online click-to-run application being streamed from a network.

### BACKGROUND

Traditionally, selling and deploying software applications over a network such as the Internet can be a challenge for larger client-side applications, such as productivity software. Considerable time may be required to download an entire client-side application, or suite of applications, even over broadband data connections. Resource consumption at a server supporting multiple instances of large application downloads can also be a hurdle to successful deployment. Large software applications may include many functional elements, some of which may not be required for initially launching the basic functionality of the applications.

A traditional user experience for network-based deployment of software may include downloading one or more large files, possibly uncompressing the files, and then installing and executing the application contained within the files. Such a user experience may not be as seamless as clicking to execute a local or preinstalled application. A multistep user experience for obtaining, installing, and executing new software may feel very different from launching a software install from a local storage device or media. An undesirable or confusing user experience may provide disincentive to customers seeking or purchasing new application packages.

It is with respect to these considerations and others that the disclosure made herein is presented.

### SUMMARY

Technologies are described herein for bootstrapping streamed and virtualized applications from a network that support a click-to-run user experience. Through the use of these technologies, a user experience can be provided for network delivered applications that is similar to, or better than, the user experience for pre-installed, or locally installed, client applications. Through an implementation of these technologies, a system for delivering applications over a network can be implemented that can operate without, or while minimizing, server-side executable code. Even without server-side code for the bootstrapping process, prerequisites, system requirements, language selection, and localization may be supported. These bootstrapping features may be deployed entirely over hypertext transfer protocol (HTTP) or other file download, or file transfer, mechanisms.

A bootstrap loader, or bootstrapper, may provide all user interface (UI) elements to launch an application from the Internet. The bootstrapper can provide a boot-like user experience even while streaming and launching an application from a network such as the Internet. The bootstrapper may stream and execute a client virtualization handler (CVH). The CVH can download and install in parallel with the initial streaming of an application. Such parallelization can significantly reduce application install time. The time reduction may be by as much as half, or more, compared to the install duration for an application installed from a network without parallelized operations.

Features of the CVH may be customized based on the application being installed. Customization may be specified within a product descriptor file associated with the application being installed. Consistent UI elements may be presented starting with the bootstrapper through to the streaming and initial execution of the associated application. The consistent UI, along with rapid streamed downloading, may provide a user with a local boot-like user experience even from an online click-to-run network streamed application.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a system for file streaming and downloading from a content distribution network to a client according to one or more embodiments presented herein;

FIG. 2 is a block diagram illustrating the flow of user experience or user interface elements during the bootstrapping of an application from a network according to one or more embodiments presented herein;

FIG. 3A is a flow diagram showing an illustrative process for bootstrapping applications from a network according to one or more embodiments presented herein;

FIG. 3B is a flow diagram showing an illustrative process for processing feature blocks according to one or more embodiments presented herein; and

FIG. 4 is a computer architecture diagram showing an illustrative computer hardware architecture for a computing system capable of implementing embodiments presented herein.

### DETAILED DESCRIPTION

The following detailed description is directed to technologies for bootstrapping streamed and virtualized applications from a network such as the Internet. Through the utilization of the technologies and concepts presented herein, a boot strap loader, or bootstrapper, can provide a local boot-like user experience even while streaming and launching an application from a network. Consistent user interface elements may be employed. The consistent user interface, along with rapid streamed downloading, can support a boot-like, click-to-run user experience even from an online application deployment scenario.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, concepts and technologies for bootstrapping streamed and virtualized applications will be described.

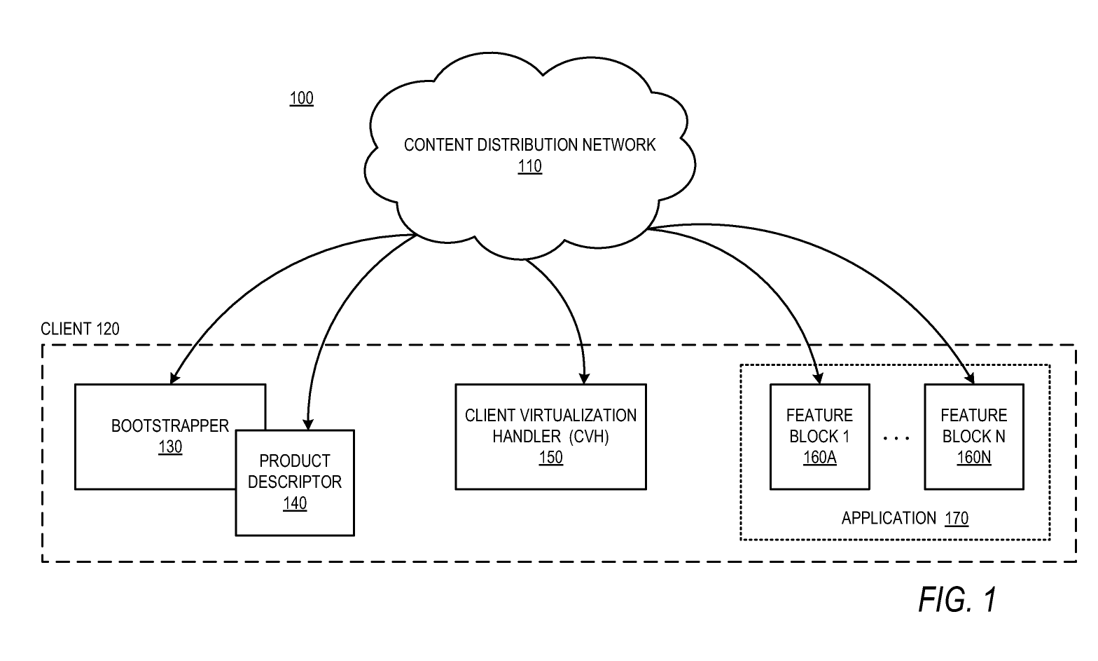

Turning first to FIG. 1, a block diagram illustrates a system 100 for file streaming and downloading from a content distribution network 110 to a client 120 according to one or more embodiments presented herein. A bootstrap loader, or bootstrapper 130, may be downloaded and executed directly from a content distribution network 110.

The bootstrapper 130 may be launched from a Web browser or similarly executed on a client 120 by a user. Launching the bootstrapper 130 can include downloading the bootstrapper from the content distribution network 110 over a network, such as the Internet. The content distribution network 110 can be one or more computer systems or servers on the network configured to support deployment of applications, other software, or related data, to users or customers upon request.

A product descriptor file 140 may be associated with an application 170 being downloaded from the content distribution network 110. The product descriptor file 140 may be retrieved from the content distribution network 110 by, or in association with, the bootstrapper 130. The bootstrapper 130 can be a light-weight executable program. The bootstrapper 130 may download in less than or approximately one second. The bootstrapper 130 can access, from the product descriptor file 140, information regarding the application being streamed or downloaded from the content distribution network 110. The product descriptor file 140 may be an extensible markup language (XML) file. The product descriptor file 140 may include the name, size, system requirements, system prerequisites, language, feature list, or other information associated with the application being streamed or downloaded from the content distribution network 110.

A client virtualization handler (CVH) 150 may be obtained by the bootstrapper 130 from the content distribution network 110. The CVH 150 may be reused between multiple applications. A search may be performed by the bootstrapper 130 to verify if the desired CVH 150 is already present on the client 120. When the desired CVH 150 is not present on the client 120, it may be downloaded or streamed from the content distribution network 110. The CVH may be of a moderate size. For example, the CVH 150 may be approximately 5, 10, or 20 MB in size, or any other similar size. The CVH 150 may also be responsible for installing or launching streamed or virtualized applications, such as application 170. The CVH 150 may support an interoperability shim. The interoperability shim and other features of the CVH 150 can support virtualized operation of applications and other software, such as application 170. The CVH 150 may also be responsible for interfacing with one or more add/remove program (ARP) modules in support of identifying new software, such as application 170, being added or removed at the client 130.

During download or installation of the CVH 150, streaming of the application 170 to be downloaded from the content distribution network 110 may begin in parallel. The application 170 may be packaged into a series of feature blocks, such a feature block 1 160A through feature block N 160N. The feature blocks may be referred to collectively or generically as feature blocks 160. The feature blocks 160 may be configured such that feature block 1 160A contains a basic set of start up functionality for the application 170 being downloaded. The client 120 may begin execution of the application 170 being downloaded upon completion of the streaming or downloading of feature block 1 160A from the content distribution network 110. Remaining feature blocks 160 may be downloaded, streamed, or trickled from the content distribution network 110 to the client 120 as one or more background operations.

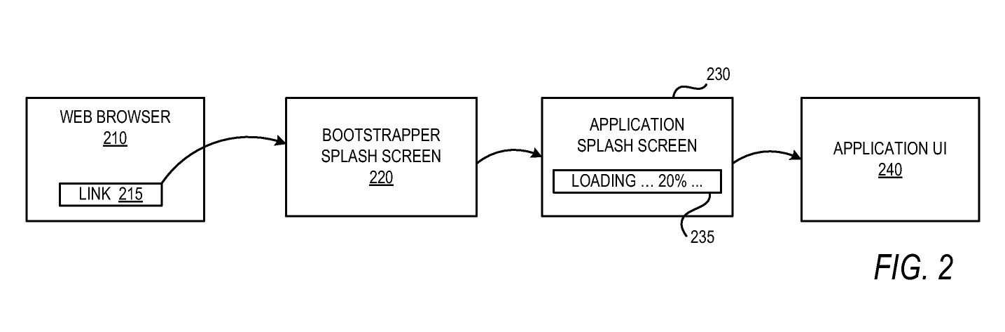

FIG. 2, is a block diagram illustrating the flow of user experience or user interface elements during the bootstrapping of an application from a network according to one or more embodiments presented herein. The user may select the purchase, trial, or download of an application 170 from the Internet using a Web browser 210, or similar client application. The user may select a link 215, or hot link or hypertext link, to launch the purchase, trial, or download of an application using a Web browser 210. Selecting the link 215, or other user action, may initiate the downloading and execution of a bootstrapper 130. Execution of the bootstrapper 130 may begin with the display of a bootstrapper splash screen 220. The bootstrapper splash screen 220 may be displayed while the bootstrapper 130 obtains the CVH 150. In addition to selecting a hypertext link 215, the application 170 may be launched from a menu such as a start menu using short cuts or other shell entry points.

During the download of the application 170, in the form of feature blocks 160, the bootstrapper 130 may display an application splash screen 230. The application splash screen 230 may include a status bar 235 for indicating the portion or percentage complete of the application 170 download. Alternatively, the status bar 235 may indicate the portion or percentage complete of downloading feature block 1 160A to begin execution of the application.

Upon completion of the streaming or downloading, the bootstrapper 130 may launch initial execution of the application 170 being downloaded from the content distribution network 110. Initial execution of the application may include display of the application UI 240. Display of the application UI 240 can seamlessly replace the application splash screen 230. While various software elements may be involved in presenting the user experience, a singular user experience may be provided. A singular user experience may be supported by coordinating a consistent look and feel between some, or all of, the bootstrapper splash screen 220, application splash screen 230 and application UI 240.

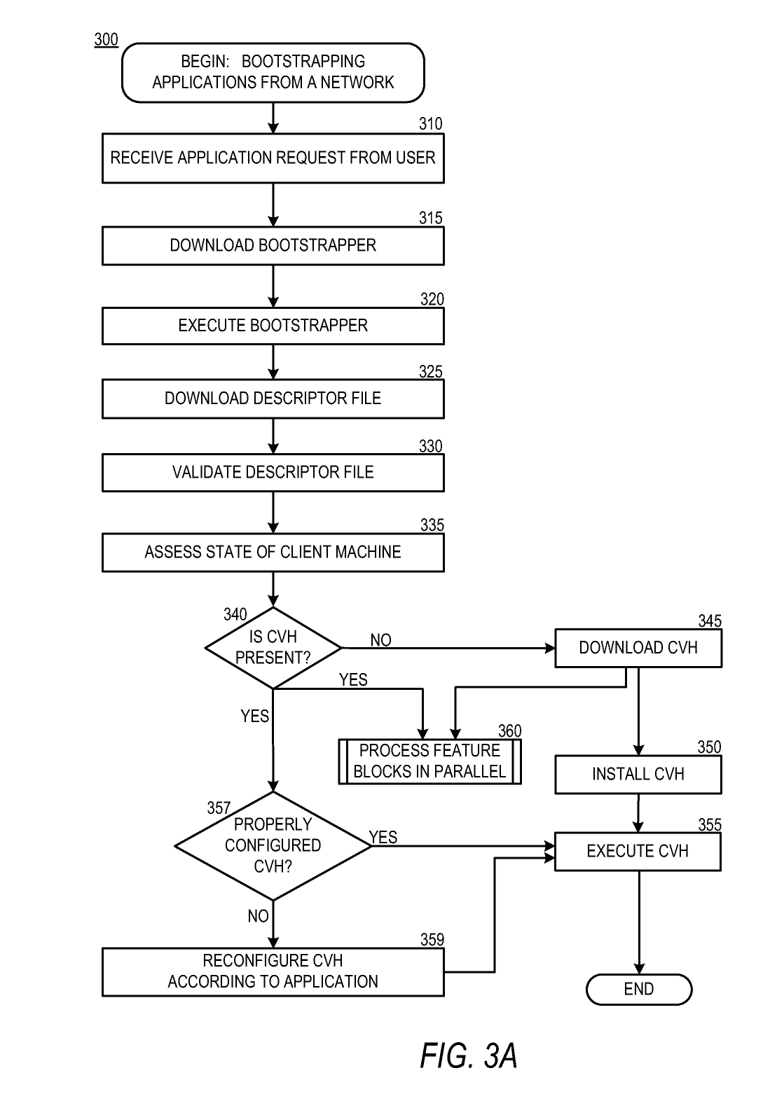

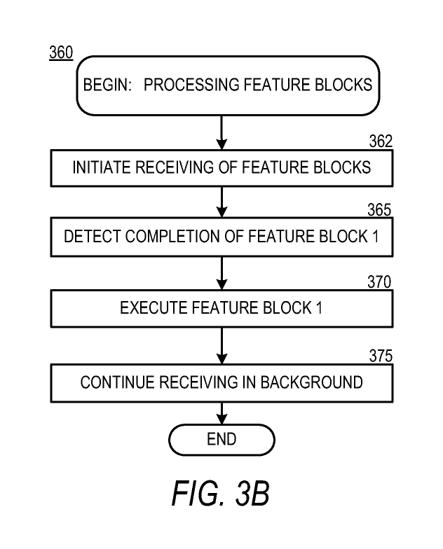

Referring now to FIG. 3A, additional details will be provided regarding the embodiments presented herein for bootstrapping streamed and virtualized application from a network. In particular, FIG. 3A is a flow diagram illustrating a method 300 for bootstrapping applications from a network according to one or more embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may be performed sequentially, in parallel, or in a different order than as described herein.

A method 300 begins at operation 310 where an application request may be received from a user. The request may initiate a click-to-run user experience to execute a desired application 170. The request may involve clicking a link 215 within a Web browser 210. Clicking the link 215 may provide a dialog to the user to execute or save an executable file associated with the bootstrapper 130. The request may involve selecting any other type of UI element.

At operation 315, the bootstrapper 130 is downloaded in response to receiving the click-to-run, or other initiation, from the user in operation 310. As discussed above, the bootstrapper 130 may be a small executable file. For example the bootstrapper 130 may be about a hundred, or a few hundred, kilobytes in size. Downloading the bootstrapper 130 may take a small amount of time to download. For example, the bootstrapper 130 may download in less than, or approximately, one second in certain circumstances. There may be a distinct bootstrapper, such as bootstrapper 130, which may be launched for each distinct application, such as application 170, or each version or language of an application, such as application 170.

At operation 320, the bootstrapper 130 downloaded in operation 315 is executed on the client 120. Continuing to operation 325, a product descriptor 140 may be downloaded by, or in association with, the bootstrapper 130. As mentioned above, the product descriptor 140 may provide information about the application 170 being streamed or downloaded. The information may include the name, size, system requirements, system prerequisites, localization information, language, and so forth for the application 170.

At operation 330, the product descriptor 140 is validated by the bootstrapper 130. Continuing to operation 335, the bootstrapper 130 can assess the state of the client 120. Assessing the state of the client 120 may be performed based on information provided in the product descriptor 140. For example, information in the product descriptor 140 regarding prerequisites or system requirements, can be checked against the client 120 before the bootstrapper 130 continues bootstrapping the application from the network.

Continuing to operation 340, the bootstrapper 130 may determine if the desired CVH 150 is present on the client 120. If the desired CVH 150 is not present on the client 120, the process 300 continues on to operation 345 where the CVH 150 is downloaded from the content distribution network 110. Upon completion of downloading the CVH 150, the process 300 continues to operation 350, where the CVH 150 is installed on the client 120. The process 300 may also trigger subroutine 360 for processing feature blocks in parallel with operation 350. The subroutine 360 for processing feature blocks in parallel is discussed in further detail with respect to FIG. 3B. After installation of the CVH 150 at operation 350, the process 300 continues to operation 355.

If instead, it is determined at operation 340 that the CVH 150 is present on the client 120, the process 300 may proceed to operation 357 where it can be determined if the CVH 150 that is present is properly configured. The process 300 may also trigger subroutine 360 for processing feature blocks in parallel with operation 357. The subroutine 360 for processing feature blocks in parallel is discussed in further detail with respect to FIG. 3B. If it is determined at operation 357 that the CVH 150 that is present is properly configured, the process 300 may continue to operation 355. If instead it is determined at operation 357 that the CVH 150 that is present is not properly configured, the CVH may be reconfigured according to the application at operation 359. The process 300 may continue to operation 355 after operation 359.

At operation 355, the CVH 150 is executed on the client 120. The CVH 150 is responsible for downloading application feature blocks 160 and for providing progress information concerning downloads. The process 300 may terminate after operation 355.

Referring now to FIG. 3B, additional details will be provided regarding the embodiments presented herein for bootstrapping streamed and virtualized application from a network. In particular, FIG. 3B is a flow diagram illustrating a subroutine 360 for processing feature blocks according to one or more embodiments presented herein. The method 360 begins at operation 362 where the receiving of feature blocks 160 associated with the application 170 is initiated. The receiving may involve streaming or downloading of the feature blocks 160. The receiving of feature blocks 160 may begin in parallel with installation of the CVH 150 or execution of the CVH 150 at operations 350 or 355. At operation 365, completion of streaming or downloading for feature block 1 may be detected. Upon detection of the completed downloading or streaming of feature block 1 160A, the basic functionality or startup features of the application 170 may be present on the client 120.

Continuing to operation 370, the application 170 may be launched by executing the code associated with feature block 1 160A. Downloading of code for feature block 1 160A may be detected as complete from operation 365. Continuing to operation 375, background receiving (downloading or streaming) of feature blocks 160 may continue while the code for feature block 1 160A begins executing.

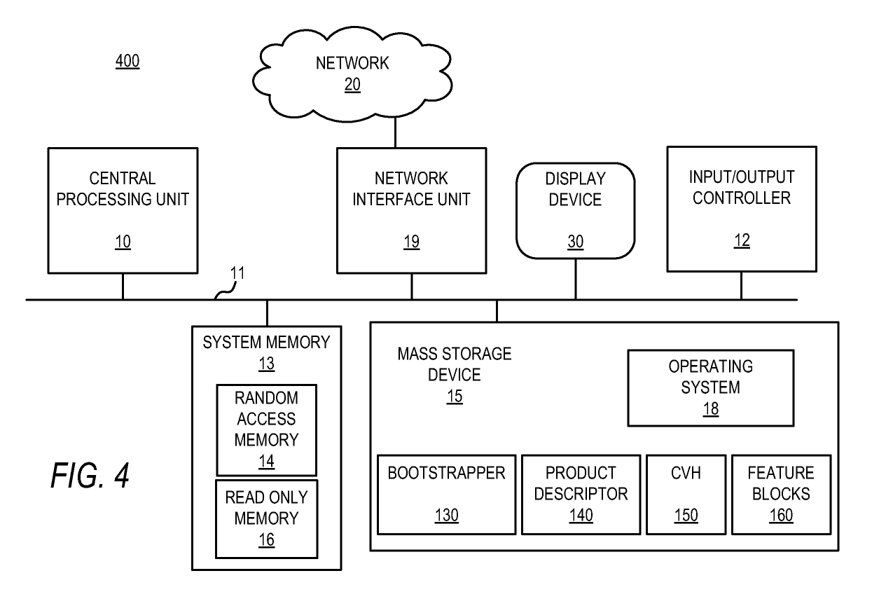

Turning now to FIG. 4, an illustrative computer architecture 400 can execute software components described herein for bootstrapping streamed and virtualized applications from a network. The computer architecture shown in FIG. 4 illustrates a conventional desktop, laptop, or server computer and may be utilized to execute any aspects of the software components presented herein. It should be appreciated however, that the described software components can also be executed on other example computing environments, such as mobile devices, television, set-top boxes, kiosks, vehicular information systems, mobile telephones, embedded systems, or otherwise. The computer architecture 400 may apply to the client 120 or any computer systems within the content distribution network 110.

The computer architecture illustrated in FIG. 4 can include a central processing unit 10 (CPU), a system memory 13, including a random access memory 14 (RAM) and a read-only memory 16 (ROM), and a system bus 11 that can couple the system memory 13 to the CPU 10. A basic input/output system containing the basic routines that help to transfer information between elements within the computer 400, such as during startup, can be stored in the ROM 16. The computer 400 may further include a mass storage device 15 for storing an operating system 18, software, data, and various program modules, such as those associated with the bootstrapper 130, the product descriptor 140, the CVH 150, and the feature blocks 160. The program modules can execute portions of software components, processes, and routines described herein.

The mass storage device 15 can be connected to the CPU 10 through a mass storage controller (not illustrated) connected to the bus 11. The mass storage device 15 and its associated computer-readable media can provide non-volatile storage for the computer 400. Although the description of computer-readable media contained herein refers to a mass storage device, such as a hard disk or CD-ROM drive, it should be appreciated by those skilled in the art that computer-readable media can be any available computer storage media that can be accessed by the computer 400.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network such as the network 20, or content distribution network 110. The computer 400 may connect to the network 20 through a network interface unit 19 connected to the bus 11. It should be appreciated that the network interface unit 19 may also be utilized to connect to other types of networks and remote computer systems. The computer 400 may also include an input/output controller 12 for receiving and processing input from a number of other devices, including a keyboard, mouse, or electronic stylus (not illustrated). Similarly, an input/output controller 12 may provide output to, a printer, or other type of output device (also not illustrated). A display device 30 may be used for providing output from the computer 400 in the form of text, graphics, video, graphical user interface, any other user interface elements, or any combination thereof.

As mentioned briefly above, a number of program modules and data files may be stored in the mass storage device 15 and RAM 14 of the computer 400, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the program modules for the bootstrapper 130, the CVH 150, the feature blocks 160, and the streamed or downloaded application for execution by the CPU 10. The mass storage device 15, the ROM 16, and the RAM 14 may also store other types of program modules.

In general, software applications or modules such as the bootstrapper 130, the CVH 150, the feature blocks 160, and the streamed or downloaded application may, when loaded into the CPU 10 and executed, transform the CPU 10 and the overall computer 400 from general-purpose computing systems into special-purpose computing systems customized to bootstrap streamed and virtualized applications from the Internet. The CPU 10 may be constructed from any number of transistors or other discrete circuit elements, which may individually or collectively assume any number of states. More specifically, the CPU 10 may operate as one or more finite-state machines, in response to executable instructions contained within the software or modules. These computer-executable instructions may transform the CPU 10 by specifying how the CPU 10 transitions between states, thereby physically transforming the transistors or other discrete hardware elements constituting the CPU 10.

Encoding the software or modules onto the mass storage device 15 may also transform the physical structure of the mass storage device 15 or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for bootstrapping streamed and virtualized applications from a network are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for bootstrapping an application over a network, the method comprising computer-implemented operations for:
receiving a request to begin bootstrapping an application to a client;
downloading a bootstrapper to the client in response to the request;
executing the bootstrapper on the client;
executing a client virtualization handler on the client in response to executing the bootstrapper; and
receiving one or more feature blocks associated with the application at the client virtualization handler for execution on the client.

2. The computer-implemented method of claim 1, further comprising computer-implemented operations for determining if the client virtualization handler is present on the client and downloading the client virtualization handler to the client in response to the client virtualization handler not being present on the client.

3. The computer-implemented method of claim 1, further comprising computer-implemented operations for executing a first one of the feature blocks in response to detecting a completion of streaming the first one of the feature blocks to the client virtualization handler.

4. The computer-implemented method of claim 1, wherein streaming one or more feature blocks comprises one or more background operations.

5. The computer-implemented method of claim 1, further comprising computer-implemented operations for downloading a product descriptor file in association with the bootstrapper.

6. The computer-implemented method of claim 5, further comprising computer-implemented operations for validating the product descriptor file.

7. The computer-implemented method of claim 1, further comprising computer-implemented operations for assessing the state of the client prior to executing the client virtualization handler.

8. The computer-implemented method of claim 1, wherein the request comprises receiving a selection of a link in a web browser, the link corresponding to the bootstrapper.

9. The computer-implemented method of claim 1, wherein bootstrapping applications over a network supports a click-to-run user experience.

10. The computer-implemented method of claim 1, further comprising computer-implemented operations for providing progress information associated with the streaming of one or more feature blocks.

11. A computer system comprising:
a processing unit;
a memory operatively coupled to the processing unit; and
a program module which executes in the processing unit from the memory and which, when executed by the processing unit, causes the computer system to bootstrap an application over a network by
receiving a request to begin bootstrapping an application to the computer system,
downloading a bootstrapper to the computer system in response to the request,
executing the bootstrapper on the computer system,
executing a client virtualization handler on the computer system in response to executing the bootstrapper, and
receiving one or more feature blocks associated with the application to the client virtualization handler.

12. The computer system of claim 11, wherein the program module further causes the computer system to determine if the client virtualization handler is present on the client and reconfigure the client virtualization handler according to parameters associated with the application.

13. The computer system of claim 11, wherein the program module further causes the computer system to execute a first one of the feature blocks in response to detecting a completion of streaming the first one of the feature blocks to the client virtualization handler.

14. The computer system of claim 11, wherein the program module further causes the computer system to download a product descriptor file in association with the bootstrapper.

15. The computer system of claim 11, wherein the program module further causes the computer system to assess the state of the client prior to executing the client virtualization handler.

16. The computer system of claim 11, wherein the request comprises receiving a selection of a link in a web browser, the link corresponding to the bootstrapper.

17. The computer system of claim 11, wherein bootstrapping applications over a network supports a click-to-run user experience.

18. The computer system of claim 11, wherein the program module further causes the computer system to provide progress information associated with the streaming of one or more feature blocks.

19. The computer system of claim 11, wherein the program module further causes the computer system to provide a consistent user interface during the bootstrapping the application over the network.

20. A computer-readable medium having computer-executable instructions stored thereon which, when executed by a computer, cause the computer to:
receive a request to begin bootstrapping an application to a client;
download a bootstrapper to the client in response to the request;
download a product descriptor file in association with the bootstrapper;
execute the bootstrapper on the client;
determine if a client virtualization handler is present on the client;
download the client virtualization handler to the client in response to the client virtualization handler not being present on the client;
execute the client virtualization handler on the client in response to executing the bootstrapper;
receive one or more feature blocks associated with the application to the client virtualization handler; and
execute a first one of the feature blocks in response to detecting a completion of receiving the first one of the feature blocks.
